(19) United States
(12) Patent Application Publication
(10) Pub. No.: US 2006/0023951 A1
(43) Pub. Date: Feb. 2, 2006

(54) Method and system for processing an input image and generating an output image having low noise

(76) Inventor: Lian Chye Simon Tan, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/900,753

(22) Filed: Jul. 27, 2004

(51) Int. Cl. G06K 9/36

(52) U.S. Cl. 382/232

(57) ABSTRACT

A method for processing an input image and generating an output image having low noise is provided. At least a homogeneous region in the input image is determined, and a mask which is indicative of the homogeneous region is generated. The input image is compressed, and both the compressed input image and the mask are stored.

### FIELD OF THE INVENTION

The invention relates generally to an image enhancement method, and more particularly to a method and system for processing an input image and generating an output image having low noise.

### BACKGROUND OF THE INVENTION

Digital images are common multimedia objects in the present digital or computer world. These images are normally stored in a memory unit in a computer system or are transmitted to other computer systems in a computer network, for example via the Internet. However, such images are usually large in size and difficult to manipulate, and therefore, are normally compressed before they are stored or transmitted.

There are generally two types of image compression techniques: lossless compression and lossy compression. With lossless compression, all information (or bits) of an image can be recovered by decompressing the compressed image. With lossy compression, certain information of the image is removed and cannot be recovered when the compressed image is decompressed. Lossy compression is used in applications which have limited memory resources or when the quality of the image is not of utmost importance.

In an example of a photo-copier machine, an image is usually scanned and stored as an image file in a memory unit of the machine before printing. The size of the memory unit in the photo-copier machine is usually limited. Hence, to conserve memory space and maximize the number of images which can be stored in the memory unit, lossy compression techniques are normally used to compress the scanned images before storing them. The compressed images are subsequently decompressed for printing. The decompressed images normally include noise due to the lossy nature of the compression technique. Such noise is very noticeable especially when the images include objects having distinct edges, for example text, against a white background. In this case, the noise appears as stray dots surrounding the objects, making the distinct edges of the objects to appear fuzzy.

To minimize the introduction of noise to the decompressed images using lossy compression techniques, lossless compression techniques can be used instead to compress the scanned images. However, lossless compression techniques have poor compression ratio which result in large file size, and hence, require large memory. Alternatively, the scanned images can be segmented and different compression techniques can be used to compress them. However, the segmentation of images and use of different compression techniques add complexity and require high processing power. It is also possible to compress the “smoother” regions of the scanned images, and enhance said regions during printing. However, the enhancement of such “smoother” regions of the images usually requires additional hardware, and hence, constrains the hardware spaces in a device or reduces the number and types of concurrent tasks that can be performed in the device.

A way to improve the quality of decompressed images which were compressed using lossy compression techniques, but yet does not significantly increase memory requirement, is therefore desired.

### SUMMARY OF THE INVENTION

In an embodiment, a method for processing an input image and generating an output image having low noise is provided. At least a homogeneous region in the input image is determined, and a mask which is indicative of the homogeneous region is generated. The input image is compressed, and both the compressed input image and the mask are stored.

### BRIEF DESCRIPTION OF THE DRAWINGS

The embodiments of the invention will be better understood in view of the following drawings and the detailed description.

FIG. 1 shows a block diagram for processing an input image in a device according to an embodiment of the invention.

FIG. 2 shows a block diagram for generating an output image from a compressed image and a white mask stored in the device according to an embodiment of the invention.

### DETAILED DESCRIPTION OF THE INVENTION

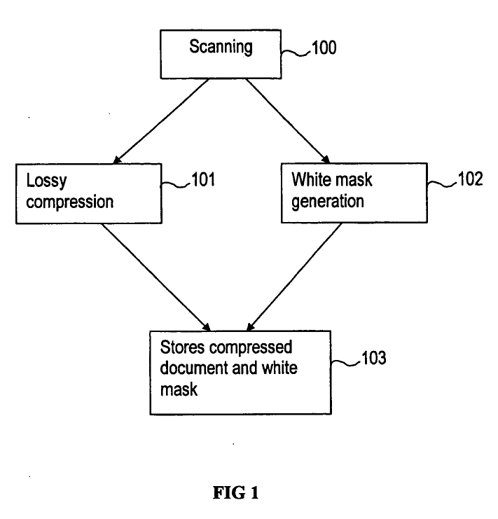

FIG. 1 shows a block diagram of an embodiment for processing an input image in a COPY function of a device. A first step 100 includes scanning an image with the device. In an embodiment, the device is a multi-function machine. The multi-function machine is a multi-purpose machine which includes scanning, printing, faxing and copying functions.

A second step 101 includes compressing the scanned image. In an embodiment, the scanned image is compressed using a compression algorithm in accordance to the Joint Photographic Experts Group (JPEG) standard (JPEG compression).

The JPEG compression algorithm is a lossy algorithm, and accordingly, some information of the scanned image is lost when the scanned image is compressed. This results in the introduction of noise when the compressed image is decompressed at a later stage to regenerate the scanned image for printing. It is also possible to compress the scanned image using other types of lossy compression algorithms such as wavelets coding or vector quantization in other embodiments.

A third step 102 includes generating a white mask based on the scanned image. The white mask is a binary pattern which corresponds to the pixels of the white area in the scanned image. Specifically, each bit in the white mask corresponds to each pixel in the scanned image. When the pixel in the scanned image is white, the corresponding bit in the white mask is “1”. Otherwise, the bit is “0”.

The color of each pixel of the scanned image can be determined based on the RGB (Red Green Blue) value of the pixel. For a 8-bit color pixel, the value of each color of the pixel varies between 0 to 255. A white pixel has a value of (255, 255, 255) and a black pixel has a value of (0, 0, 0). Therefore, a threshold can be assigned such that when all the values of the color in the pixel are above the threshold, the corresponding bit in the white mask is determined to be “1”.

To reduce the size of the white mask, a subsampled white mask can be used. For a subsampling factor of 2, each bit in the subsampled white mask corresponds to a 2×2 pixel block in the scanned image. In other words, each bit in the subsampled white mask is “1” only if all the 4 pixels in the corresponding 2×2 pixel block of the scanned image are white. A larger subsampling factor may be used in other embodiments to further reduce the size of the white mask, especially when the size of the scanned image is large (e.g. has a large number of pixels).

It should be noted that a white mask is used in the description of this embodiment because it is assumed that the scanned image includes text objects against a white background. However, it is also possible to generate a mask which corresponds to a different color region in the scanned image. In an example of a image having an object against a blue background, a blue mask which corresponds to the blue region of the scanned image can be generated. In this example, each bit in the blue mask is determined to be “1” only when the corresponding pixel of the scanned image has a value of (0, 0, 255).

A final step 103 includes storing both the compressed scanned image, i.e. the JPEG image, and the white mask corresponding to the scanned image in a memory unit of the device. The stored compressed scanned image and the white mask are subsequently retrieved and processed to generate an output image which is then printed to complete the COPY function of the device. In an alternative embodiment, the compressed scanned image and the white mask are transmitted to another device (a receiving machine). The receiving machine upon receiving the compressed image and the white mask processes them to generate an output image which is then printed.

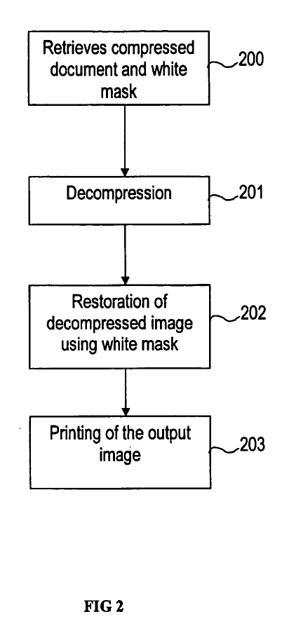

FIG. 2 shows a block diagram in an embodiment for generating an output image from a compressed scanned image and a white mask, for example, in a COPY or PRINT function of the device.

A first step 200 includes retrieving the compressed scanned image and the white mask from the memory unit of the device. In an alternate embodiment, the compressed scanned image and the white mask are received from a sending machine. A second step 201 includes decompressing the compressed scanned image. The decompression algorithm to be used depends on which compression algorithm was used in compressing the scanned image. In this embodiment, the decompression algorithm in accordance to the JPEG standard is used since the scanned image was compressed using the JPEG compression.

A third step 202 includes applying the white mask to the decompressed image to restore the white areas of the decompressed image. Specifically, each pixel in the decompressed image corresponding to a “1” bit in the white mask is determined to be a white pixel, and accordingly, a value of (255, 255, 255) is assigned to the pixel. When a 2×2 subsampled white mask is used, all the 4 pixels in a 2×2 pixel block of the decompressed image corresponding to a “1” bit in the white mask are determined to be white pixels.

Similarly, it should be noted that a different color mask, for example a blue mask, can be applied to restore the blue areas of the decompressed image. This is provided that the blue mask was previously generated and stored by the device.

Since the scanned image was compressed using a lossy compression algorithm, noise is introduced into the compressed scanned image. When the compressed scanned image is decompressed, the noise may become obvious, especially in the white background areas near the objects. Therefore by applying the white mask to the decompressed image, such “obvious” noise is removed. A final step 203 involves printing the restored decompressed image with the device.

Other embodiments to reduce the size of the mask, and hence, the amount of memory needed to store both the compressed scanned image and the corresponding mask are possible. In an embodiment, the generated mask is compressed using a lossless compression algorithm before being stored in the memory unit of the device. The compression of the mask requires additional computing resources. In another embodiment, a large subsampling factor of the mask, for example a subsampling factor of 4, is used. The optimal subsampling factor and the need for lossless compression of the mask are based on a trade-off between limited memory resources, available computing resources and acceptable print quality of the output image.

Although a multi-function machine is used as the device in one embodiment, it is also possible to use the method in other devices such as a viewer program installed in a computer, a digital camera or the like, in other embodiments.

In an embodiment, a viewer program is installed in a computer. A image is scanned using a scanner. A white mask is generated based on the scanned image, and the scanned image is compressed. Both the compressed scanned image and the white mask are stored in a memory unit of the scanner or in a storage medium connected to the scanner. When a user at the computer requests to view the scanned image using the viewer program, the compressed scanned image is decompressed and the white areas of the decompressed image are restored by the white mask to generate an output image. The output image is displayed on a computer screen of the computer. The decompression of the compressed image and the restoration of the decompressed image using the white mask may be performed in the scanner or in the computer of the user.

In another embodiment, a digital camera has a “text-mode” function adapted to capture text images. A text image is first captured using the digital camera. A white mask which is indicative of the white area of the captured image is generated, and the captured image is compressed. Both the compressed image and the white mask are stored in a memory unit of the digital camera. When a user requests to view the captured image on a LCD (Liquid Crystal Display) of the digital camera, the compressed image and the white mask are retrieved from the memory unit. The compressed image is decompressed and the white mask is applied to the decompressed image to restore the white areas of the decompressed image to generate an output image. The output image is displayed on the LCD of the digital camera.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for processing an input image, and generating an output image having low noise, the method comprising:
determining at least one homogeneous region in the input image;
generating a mask which is indicative of the at least one homogeneous region in the input image;
compressing the input image; and
storing the compressed input image and the mask.

2. The method of claim 1, further comprising:
decompressing the compressed input image; and
applying the mask to the decompressed input image to restore the at least one homogeneous region of the decompressed input image, thereby generating the output image.

3. The method of claim 1, wherein the at least one homogeneous region in the input image is determined based on color.

4. The method of claim 3, wherein the color used for determining the homogeneous region in the input image is white.

5. The method of claim 1, wherein the input image is compressed in accordance to the Joint Photographic Experts Group (JPEG) standard.

6. The method of claim 2, wherein the compressed input image is decompressed in accordance to the Joint Photographic Experts Group (JPEG) standard.

7. The method of claim 1, wherein the mask is generated as a bit pattern with each bit corresponding to at least a pixel in the input image.

8. The method of claim 7, wherein each bit of the mask corresponds to a 2×2 pixel block in the input image.

9. A processing system for processing an input image, and generating an output image having low noise, the processing system comprises:
a determination unit being adapted to determine at least one homogeneous region in the input image;
a generation unit being adapted to generate a mask which is indicative of the at least one homogeneous region in the input image;
a compression unit being adapted to compress the input image; and
a storage unit being adapted to store the compressed input image and the mask.

10. The processing system of claim 9, further comprises:
a decompression unit being adapted to decompress the compressed input image; and
an application unit being adapted to apply the mask to the decompressed input image to restore the homogeneous region of the decompressed input image, thereby generating the output image.

11. The processing system of claim 9, wherein the determination unit is being adapted to determine the at least one homogeneous region in the input image based on color.

12. The processing system of claim 11, wherein the color of the homogeneous region in the input image is white.

13. The processing system of claim 9, wherein the compression unit is being adapted to compress the input image in accordance to the Joint Photographic Experts Group (JPEG) standard.

14. The processing system of claim 9, wherein the mask is a bit pattern with each bit corresponding to at least a pixel in the input image.

15. The processing system of claim 14, wherein each bit of the mask corresponds to a 2×2 pixel block in the input image.

16. A program storage device readable by a computing device, tangibly embodying a program of instructions, executable by the computing device to perform a method for processing an input image, and generating an output image having low noise, the method comprising:
determining at least one homogeneous region in the input image;
generating a mask which is indicative of the at least one homogeneous region in the input image;
compressing the input image; and
storing the compressed input image and the mask.
